(19) United States
(12) Patent Application Publication
(10) Pub. No.: US 2012/0185558 A1
(43) Pub. Date: Jul. 19, 2012

(54) DATA STORAGE MANAGEMENT

(76) Inventor: Scott W. Ryder, Los Altos, CA (US)

(21) Appl. No.: 13/007,571

(22) Filed: Jan. 14, 2011

(51) Int. Cl. G06F 15/16

(52) U.S. Cl. 709/217

(57) ABSTRACT

Methods, systems, and apparatus, including computer programs encoded on a computer storage medium, for data storage management. In one aspect, a method includes receiving a request to store one or more data items from a client device; identifying one or more remote storage locations for storing the one or more data items; creating header snips corresponding to the one or more remote storage locations; and sending the header snips to the client device.

### BACKGROUND

This specification relates to data storage management.

Conventional systems allow for both local storage of data items (e.g., stored on a user device) as well as storage at one or more remote storage locations. Different remote storage locations can have different interfaces for communicating with client devices. As a result, a client typically maintains configuration information to communicate with respective remote storage locations for uploading or retrieving data items.

### SUMMARY

This specification describes technologies relating to data storage management.

In general, one aspect of the subject matter described in this specification can be embodied in methods that include receiving a request to store one or more data items from a client device; identifying one or more remote storage locations for storing the one or more data items; creating header snips corresponding to the one or more remote storage locations; and sending the header snips to the client device. Other embodiments of this aspect include corresponding systems, apparatus, and computer programs recorded on computer storage devices, each configured to perform the operations of the methods.

These and other embodiments can each optionally include one or more of the following features. identifying one or more remote storage locations includes examining heuristics associated with the data item to be stored. The heuristics include the size of the data item. The heuristics include a determined cost for the data item. Receiving the request to store one or more data items includes receiving a fingerprint identifier for each of the one or more data items. Creating a particular header snip includes generating a HTTP header for communicating with the particular interface of the corresponding identified remote storage location. The HTTP header includes a host, port, and URL associated with the remote storage location. Creating a particular header snip includes security and access credentials for a corresponding remote storage location. The method further includes sending instructions to the client device on how to divide the one or more data items, where a header snip corresponds to each respective split portion. The instructions on how to divide the one or more data items includes a size of each split portion.

In general, one aspect of the subject matter described in this specification can be embodied in methods that include receiving, from a client device, a request to download one or more data items; identifying one or more remote storage locations in which the one or more data items are located; creating one or more headers corresponding to the one or more remote storage locations; and sending the header snips to the client device. Other embodiments of this aspect include corresponding systems, apparatus, and computer programs recorded on computer storage devices, each configured to perform the operations of the methods.

These and other embodiments can each optionally include one or more of the following features. Receiving a request to download one or more data items includes receiving a fingerprint identifier for each of the one or more data items. Identifying one or more remote storage locations includes using the received fingerprint identifiers to locate the corresponding remote storage locations for the requested one or more data items. Creating a particular header includes generating a HTTP header for communicating a data request from the corresponding remote storage location. The HTTP header includes a host, port, and URL associated with the remote storage location.

In general, one aspect of the subject matter described in this specification can be embodied in methods that include sending a request to a storage manager to store one or more data items; receiving one or more header snips from the storage manager, each header snip corresponding to a particular remote storage location; prepending each of the one or more header snips to corresponding one or more data items; and sending the one or more data items to the corresponding remote storage locations. Other embodiments of this aspect include corresponding systems, apparatus, and computer programs recorded on computer storage devices, each configured to perform the operations of the methods.

In general, one aspect of the subject matter described in this specification can be embodied in methods that include sending a request to a storage manager to retrieve one or more data items; receiving one or more header snips from the storage manager, each header snip corresponding to a particular remote storage location; prepending each of the one or more header snips to one or more corresponding requests for the one or more data items; and sending the one or more requests to the corresponding remote storage locations. Other embodiments of this aspect include corresponding systems, apparatus, and computer programs recorded on computer storage devices, each configured to perform the operations of the methods.

Particular embodiments of the subject matter described in this specification can be implemented so as to realize one or more of the following advantages. Client devices do not need to maintain configuration information for remote storage locations. Central management can keep track of client data and can identify remote storage locations taking into account a number of different criteria. Data can be moved between remote storage locations independent of individual user devices (e.g., without the client needing to change any configuration information or be aware of the changes). In particular client devices do not need any specialized or custom code to deal with storage providers. This includes, for example, configuration information, business logic, security policies, or protocol specifics as implemented in code in the client. New storage locations can be added at any time and, for example, using entirely different HTTP based protocols, while remaining accessible by the client device without performing any client changes.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagram of an example system for uploading of data items.

FIG. 2 is a flow diagram of an example process for storage management.

FIG. 3 is a flow diagram of an example process for requesting data storage.

FIG. 4 is an block diagram of example header snips and data to be stored.

FIG. 5 is a diagram of an example system for downloading of data items.

FIG. 6 is a flow diagram of an example process for storage management.

FIG. 7 is an example system architecture.

Like reference numbers and designations in the various drawings indicate like elements.

### DETAILED DESCRIPTION

A storage manager can maintain information about remote storage locations for multiple clients. As a result, individual client devices do not need to track the storage locations for different data items, or portions of data items. Additionally, the individual client devices do not need to maintain configuration information for communicating with different remote storage locations.

When a data item is to be uploaded to a remote storage location by a client device, the client device sends a request to the storage manager. The storage manager identifies a remote storage location for storing the data item. The storage manager then generates all of the corresponding headers (e.g., HTTP headers) required to access the remote storage location. This header snip describes how the client device can interface with the corresponding remote storage location (e.g., corresponding to a particular storage device). Thus, client devices do not need any specialized or custom code to deal with particular storage locations.

For example, the header snips can include security and access credentials so that the client device does not need to store or be aware of these credentials locally. The header snip is sent to the client device for prepending to an upload request for the data item. The client device can then upload the data item according to the header snip (e.g., identifying a host and port for the remote storage device).

In some implementations, the storage manager can determine that a data item should be divided into two or more portions for upload to different remote storage devices. Multiple header snips can be generated, one for each portion of the data item, along with instructions for how much data of the data item to be included in each portion.

Similarly, data items are retrieved from remote storage by sending a request to the storage manager. The storage manager provides one or more header snips corresponding to the remote storage location or locations of the data items, access credentials, and access protocol specifics. The client devices can then prepend each received header snip to a request for data and send the request to the corresponding remote storage location.

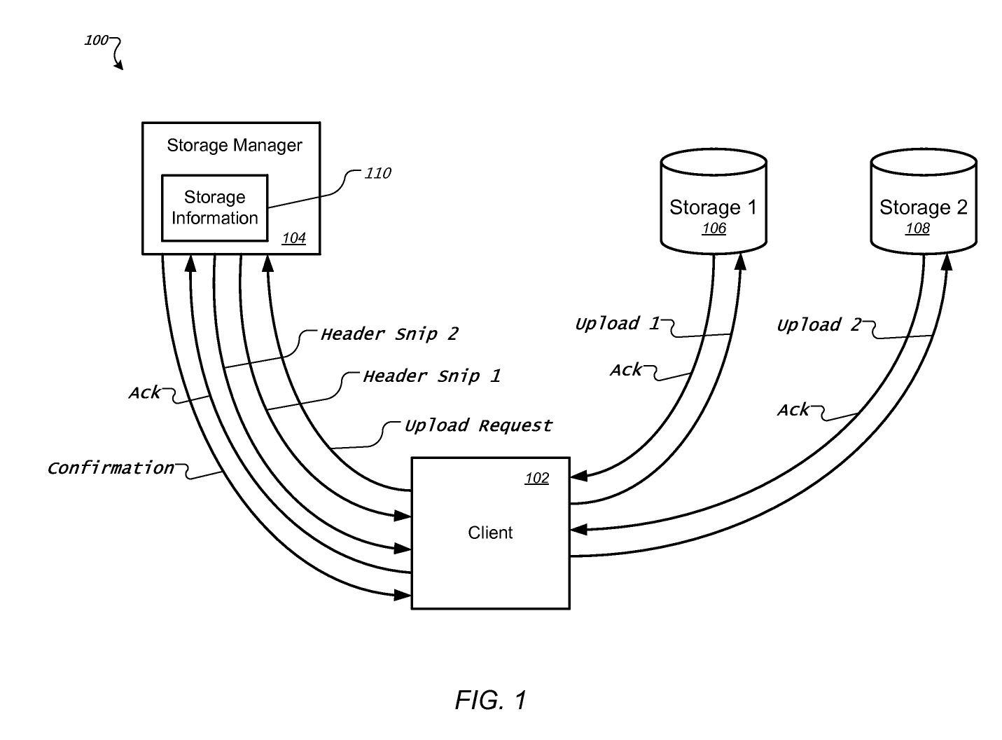

FIG. 1 is a diagram of an example system 100 for uploading of data items. The system 100 includes a client 102, a storage manager 104, remote storage device 106, and remote storage device 108. The client device 102 can communicate with the storage manager 104 and the remote storage devices 106 and 108 through a network (e.g., a wide area network (WAN), a local area network (LAN), etc.). The communication can use wired or wireless networks (e.g., Wi-Fi, cellular, or other wireless networks), or a combination of both.

The client device 102 can be various types of computing devices including desktop and notebook computers, mobile phones, tablet devices, personal data assistants, etc. In some implementations, the storage manager 104 is a remote server or other remote computing device. The storage manager 104 can be part of an independent server or, in some implementations, part of another system. Each of the remote storage devices 106 and 108 can be different types of storage devices. Each of the remote storage devices 106 and 108 can use different interfaces and other configuration information in order to communicate with other devices including the client device 102. Additionally, each of the remote storage devices 106 and 108 can be operated by different third party providers.

To upload a data item, the client 102 sends an upload request to the storage manager 104. The data item can be, for example, a file or other data. The storage manager 104 identifies a portion of the data item to be stored on remote storage device 106 and a portion to be stored on remote storage device 108 (e.g., by splitting the data item into two portions). The storage manager 104 can store identified storage locations in storage information 110, for example, so that the file can be identified when a request for retrieval is received. The storage information 110 can include a database or table that associates one or more identifiers for the data item with their corresponding storage locations.

The storage manager 104 generates header snips for the two portions identifying communication information for the respective storage devices 106 and 108. For example, the header snips can be HTTP header snips identifying hostname information for the corresponding storage device (e.g., a host domain name and URL). The HTTP header snips can also identify, for example, security and access credentials, as well as protocol information. The storage manager 104 sends the header snips to the client 102. The storage manager 104 can also send additional information, for example, instructions on how many portions to divide the data item into and the size of each portion.

The client 102 prepends the received header snip to a data upload request including the corresponding portion of the data item to remote storage device 106 and remote storage device 108, respectively. The received header snips thus allows the client 102 to communicate with each respective storage location. A message (e.g., an acknowledgement) is received from remote storage 106 and remote storage device 108 following the upload. However, the messages are formatted for the communication of the particular storage devices. These messages are therefore passed on to the storage manager 104 from the client 102. The storage manager 104 reads the messages. If, for example, the message is an acknowledgement of successful upload on the remote storage devices 106 and 108, the storage manager 104 can then send a confirmation message back to the client 102.

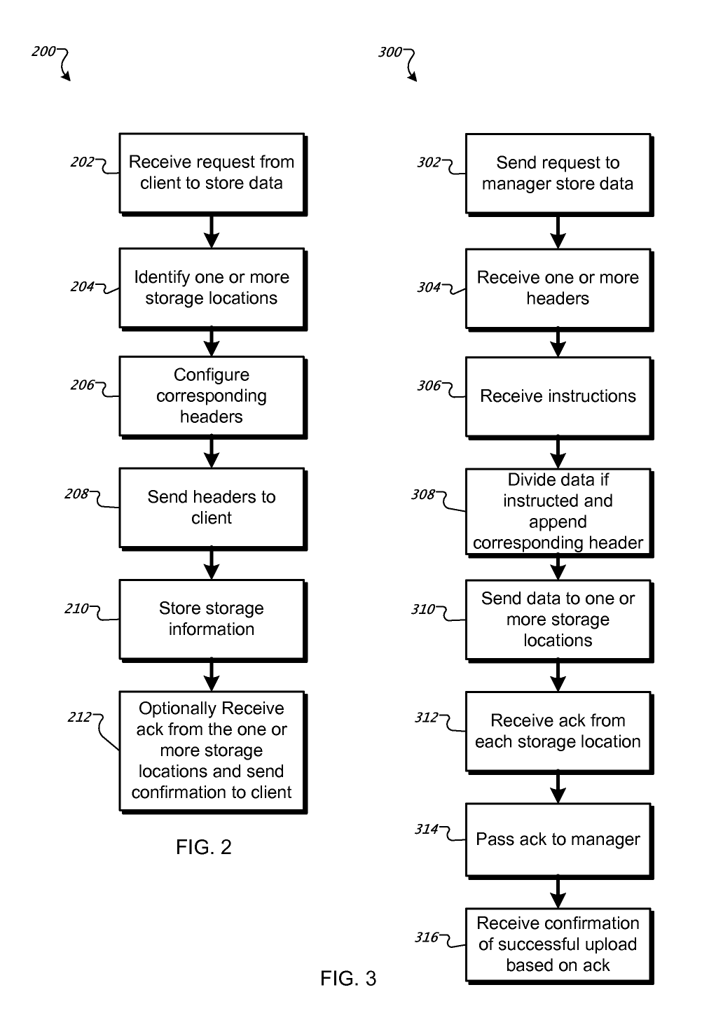

FIG. 2 is a flow diagram of an example process 200 for storage management. The process can be performed, for example, by a system including one or more computing devices, e.g., the storage manager 104 of FIG. 1.

A request is received from a client device to store one or more data items (202). For example, the request can be to remotely store a particular file or files. For convenience, the process 200 will generally describe a request to upload a single data item. The request can include an identifier for each data item, for example, a fingerprint. The fingerprint identifier for a data item can be generated on a client device, for example, by performing a hash function on the data item. In some other implementations, an identifier can be assigned by the client device instead of using the content of the data item itself. This identifier is a unique identifier that can be used to later identify the data item, for example, when requesting to retrieve the data item from the corresponding remote storage location. The request can also include additional information, for example, the size of the data item, the geographic location of the client device, and/or a user identifier. In some implementations, the request can include a desired level of protection (e.g., the security of the storage), information describing sharing with others, tags or “social media” metadata, or other arbitrary metadata.

One or more storage locations are identified for storing the data item (204). Identifying the storage locations can include using one or more heuristics to determine whether to divide the data item into two or more portions and to identify one or more appropriate remote storage locations. The storage manager can process the heuristics with respect to a number of available remote storage locations in order to identify the storage location or locations for the data item.

The heuristics can include a cost heuristic associated with the data item. The cost heuristic can be based on the size of the data item and the speed of the client network for uploading the data item. The remote storage location having a lowest cost can be selected or cost can be a factor along with other heuristics in selecting the remote storage location.

The heuristics can also include geography, security, and properties of the remote storage locations including load balancing and storage availability. For example, a remote storage location within a same geographical region (e.g., country, state, or other region) as the user can be preferred over a remote storage location outside a particular geographical region. In another example, the size of the data item can be used to determine if an available storage location has enough room for the data item or whether the data item should be split into two or more portions to be separately uploaded to different remote storage locations.

In a further example, the storage device can take load balancing among different remote storage locations into account. In some implementations, different remote storage locations are suitable for securely storing data items (e.g., encryption of personal data, for example, a user's e-mail) while other remote storage locations are suitable for storing data requiring less security (e.g., for generic data, for example, a popular music file that does not include personal information of the user).

The storage manager configures corresponding header snips, respectively, for the identified one or more remote storage locations (206). The header snips provide information for communicating with a particular remote storage location. In some implementations, the header snip is a hypertext transfer protocol (HTTP) header that includes the particular parameters for interfacing with a specific remote storage location. For example, the header snip can include a particular hostname URL (e.g., host: storage1.com) for the remote storage location.

The header snips and instructions are sent to the client device (208). The instructions can include, for example, instructions to divide the data item into two or more portions and what size to make each portion. The instructions can also include instructions to prepend the particular data portions of the data item to the received header snips in order to upload the data. Thus, the response includes the headers and access instructions (e.g., URL) for each storage location and the list of parts of the file (if not the whole file) to send to each. Additionally, in some implementations where the storage request includes multiple files, the response would include some grouping of those files. For example, a client device request that indicates four files to be stored the response instructions can include instructions to send the first through third files to a first storage location, the first 50% of the fourth file to a second storage location and the last 50% of the fourth file to a third storage location.

Information about the data item is stored (210). For example, the storage manager can record the identified storage locations with the associated data item or portion of data item. For example, a database or table data structure can associated file identifiers (e.g., unique fingerprints for the data item) with the one or more remote storage locations. If a storage location has to be changed for some reason (for example, because an agreement with a particular third party remote storage location has ended) the field in the stored information can be updated transparently to the client to a new storage location to which the data was transferred without the client having any knowledge of this having occurred.

An acknowledgement is optionally received from the client as received from the one or more remote storage locations (212). The acknowledgement is in the communication format of the remote storage location and may not be readable by the client, which therefore passes it on. A confirmation can be sent to the client following receipt of an acknowledgement indicating a successful upload. If the message is an error message (e.g., the upload was not successful), the client can receive instructions to attempt the upload again or a new header snip of a different remote storage location.

FIG. 3 is a flow diagram of an example process 300 for requesting data storage. The process can be performed, for example, by a system including one or more computing devices, e.g., the client device 102 of FIG. 1.

For a data item to be uploaded (e.g., a file to upload) a request is sent to a storage manager (302). The request includes an identifier of the data item or data items to be uploaded as well as additional information (e.g., size of data item and client information).

One or more header snips are received (304). The received header snips provide information for interfacing with a corresponding remote storage location. Instructions are also received (306). The instructions can indicate how to apply the one or more header snips to the data item. For example, the instructions can indicate that the data item should be separated into multiple portions where the received headers correspond to a particular portion of the data item.

If the instructions include a separation of data, the data item is divided as instructed and respective headers are prepended to the divided portions of the data item (308). The data can be divided using conventional data chunking techniques as well as any system specific data chunking such that the instructed data portions are generated.

The data item is sent to the one or more remote storage locations (e.g., as respective portions of the data item appended to received header snips) (310). For example, the data item can be sent as respective portions of the data item appended to request headers including the received header snips.

Acknowledgements are received from each remote storage location to which data was sent (312). For example, each remote storage location can send an acknowledgement upon successful upload. In some other implementations, a non-acknowledgement can be sent if there is an error in the upload. These messages from the remote storage location may not be readable by the client device. In particular, the client device usually does not have code or configuration information that would allow the client device to parse the response. All the client device is aware of is that the transaction (e.g., the data upload) is complete and that the storage location may have sent a bunch of data back at the end of the upload. However, the client device cannot understand that received data so it forwards it to the storage manager. The storage manager can then send a response (e.g., a translation) of the message in a form that the client can understand. Consequently, the messages (e.g., the acknowledgement) are sent to the storage manager which can process the messages (314). A return confirmation can be received from the storage manager indicating a successful upload (316).

In some implementations, an error notice can be returned if there was a problem uploading. This can lead to the client attempting the upload again or to the storage manager providing a new header snip for an alternative remote storage location or locations in which the error occurred. In some other implementations, no messages are received from the remote storage locations. In other implementations, the messages are received but are not passed on to the storage manager.

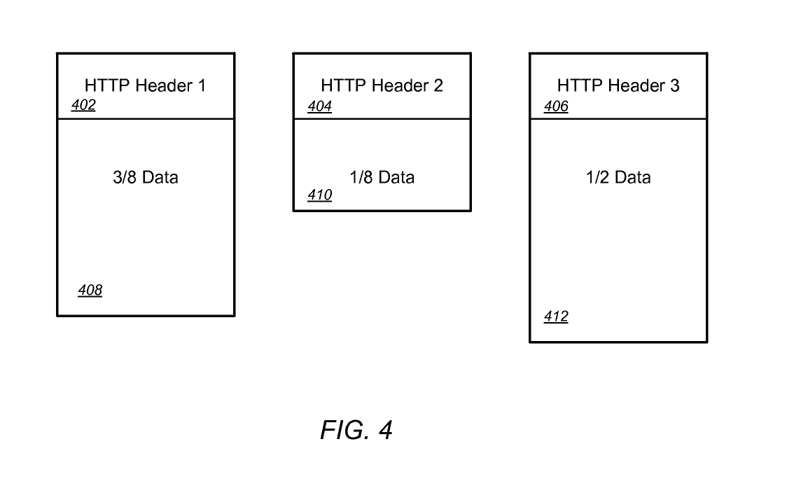

FIG. 4 is an example block diagram of HTTP headers and data to be stored. In particular, FIG. 4 shows three HTTP headers 402, 404, and 406, prepended to three different portions of a data item 408, 410, and 412 to be uploaded to respective remote storage locations. For example, the HTTP headers could have been received in response to a request to store a data item along in instructions specifying a division of the data item into three portions. Alternatively, just a portion of the respective HTTP headers were received as header snips in response to the request. Each HTTP header 402, 404, and 406 can provide information for communicating with a different remote storage location. Each portion of the data item 408, 410, and 412 are not required to be the same size. For example, the storage manager can determine different sizes according to various criteria, e.g., storage cost, geography, network speed, security, redundancy, file type specifics (e.g., audio of a movie versus video of a movie), etc. As shown in FIG. 4, the data portion 408 is ⅜ of the data item, the data portion 410 includes ⅛ of the data item, and the data portion 412 includes ½ of the data item.

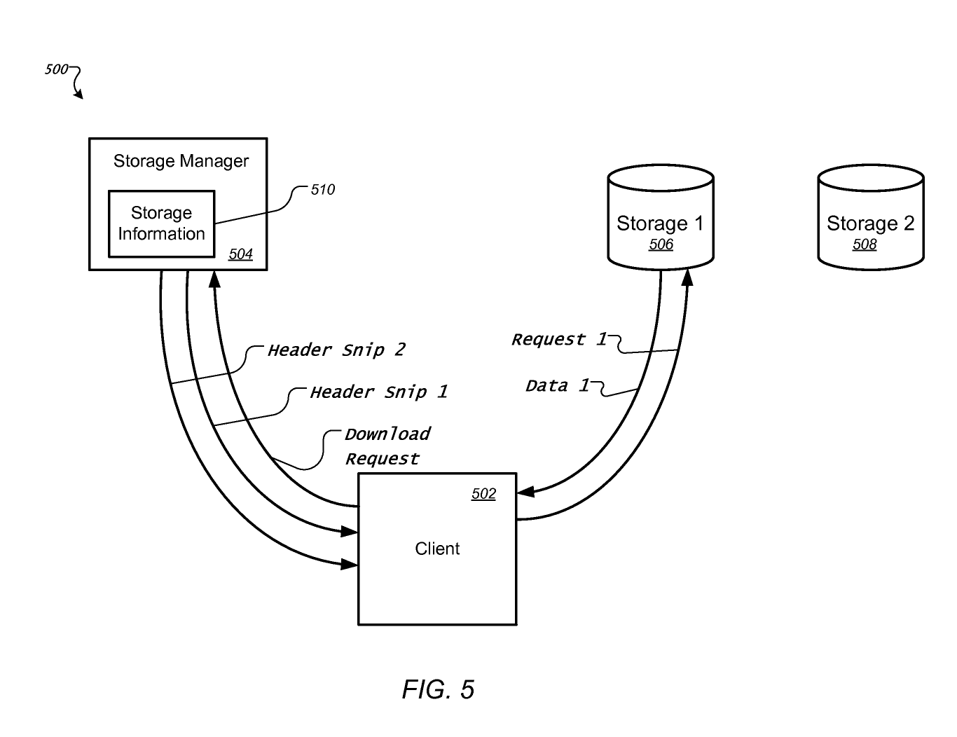

FIG. 5 is a diagram of an example system 500 for downloading of data items. The system 500 includes a client 502, a storage manager 504, remote storage device 506, and remote storage device 508. The client device 502 can communicate with the storage manager 504 and the remote storage devices 506 and 508 through a network (e.g., a wide area network (WAN), a local area network (LAN), etc.). The communication can use wired or wireless networks (e.g., Wi-Fi, cellular, or other wireless networks), or a combination of both.

The client device 502 can be various types of computing devices including desktop and notebook computers, mobile phones, tablet devices, personal data assistants, etc. In some implementations, the storage manager 504 is a remote server or other remote computing device. Each of the remote storage devices 506 and 508 can be different types of storage devices. Each of the remote storage devices 506 and 508 can use different interfaces and other configuration information in order to communicate with other devices including the client device 502. Additionally, each of the remote storage devices 506 and 508 can be operated by different third party providers.

To retrieve a data item stored in one or more remote storage devices, the client 502 sends a download request to the storage manager 504. The data item can be, for example, a file or other data. The storage manager 504 can identify the data item as stored on a particular remote storage device (e.g., remote storage device 506). In some implementations, the data item can be stored on more than one remote storage device (e.g., the data item was separated into two portions when stored).

The storage manager 504 can use storage information 510 to identify the location of the stored data item. In particular, the storage manager 504 can use an identifier of the data item, e.g., a fingerprint identifier, to identify corresponding remote storage device 506 as housing the data item. The storage information 510 can be a database or table that associates one or more identifiers for the data item with their corresponding storage locations. Other metadata can be stored, e.g., any information that the storage manager could search the database against.

The storage manager 504 generates a header snip for the data item identifying communication information for the corresponding remote storage device 506. For example, the header snip can be an HTTP header snip embodying all of the access specifics (security, protocol, etc.) needed to access the data. The storage manager 504 sends the header snip to the client 502.

The client 502 sends the header snip to the remote storage device 506 identified in the information received in the response to the request (e.g., a URL). The data item is then received from the remote storage device 506.

In some implementations, portions of the data item are requested from multiple remote storage locations. The client 502 can then reassemble the portions of the data item once received.

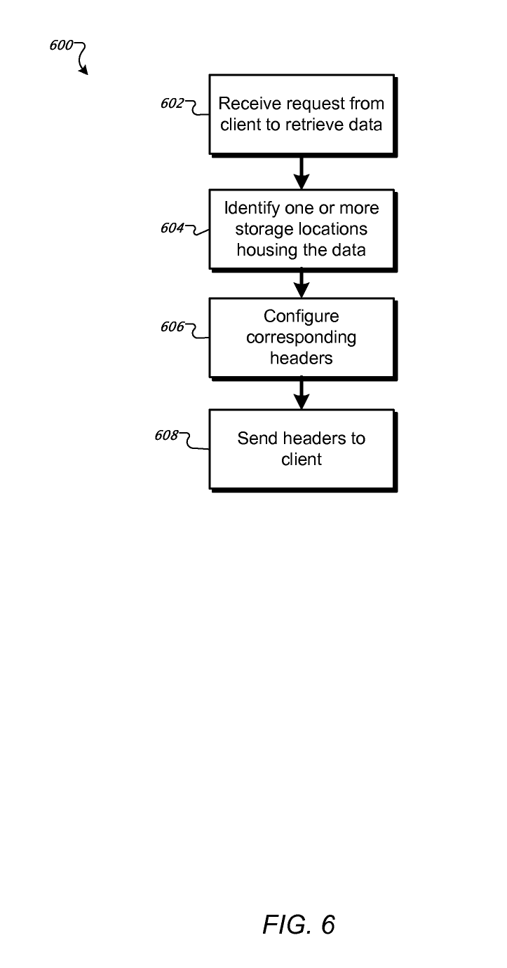

FIG. 6 is a flow diagram of an example process 600 for storage management. The process can be performed, for example, by a system including one or more computing devices, e.g., the storage manager 104 of FIG. 1.

A request is received from a client device to retrieve one or more data items (602). For example, the one or more data item can be a particular file or files. The request can include a unique identifier for the data item, for example, a fingerprint. The fingerprint identifier for each data item can be generated, for example, by performing a hash function on the data item. In particular, this identifier was previously provided to the storage manager when the data item was remotely stored (e.g., as described above with respect to FIG. 2).

One or more storage locations are identified as storing the requested data item (604). Identifying the storage locations can include using the received identifier or identifiers to identify corresponding remote storage locations associated with those identifiers. For example, a database or table structure can associate each unique identifier with one or more remote storage locations.

The storage manager creates respective header snips for the identified one or more remote storage locations (606). The header snips provide information for communicating with a particular remote storage location. In some implementations, the header snip is a Hypertext Transfer Protocol (HTTP) header that includes the particular parameters for interfacing with a specific remote storage location. For example, the header snips include a particular hostname URL (e.g., host: storage1.com) for the remote storage location, security access credentials, etc. as described above.

The one or more header snips are sent to the client device (608). The client device can prepend the one or more header snips to respective header requests which are then sent to the corresponding one or more remote storage locations. The client can then receive the requested data from the remote storage locations (e.g., as a single data item or as two or more portions of a data item which can then be reassembled at the client).

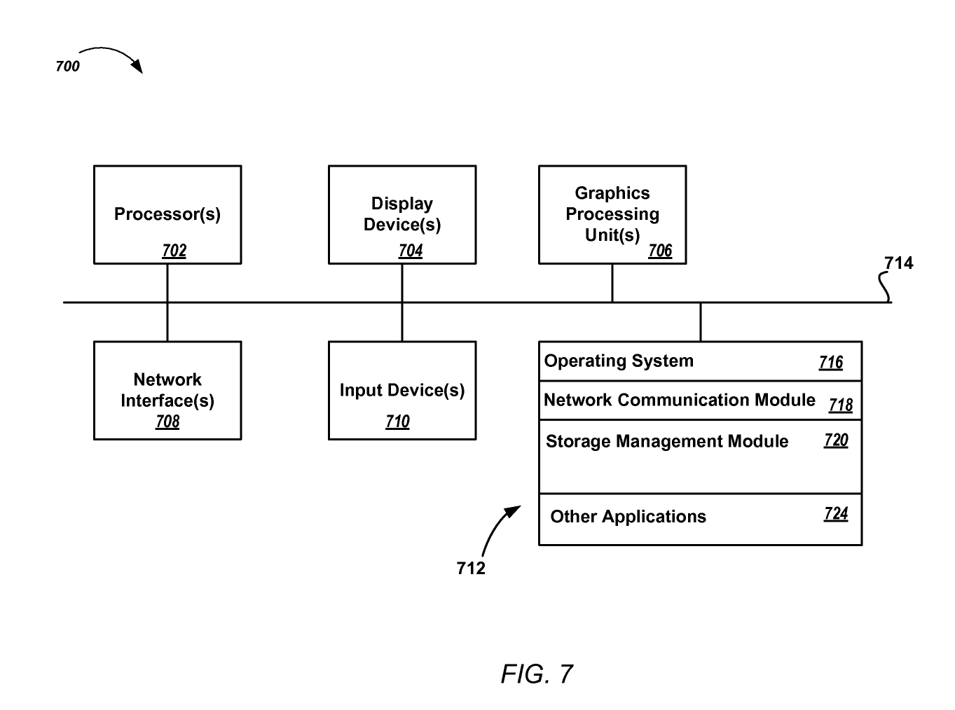

FIG. 7 illustrates an example architecture of a system 700. The system architecture 700 is capable of performing operations for storage management. The architecture 700 includes one or more processors 702 (e.g., IBM PowerPC, Intel Pentium 4, etc.), one or more display devices 804 (e.g., CRT, LCD), graphics processing units 706 (e.g., NVIDIA GeForce, etc.), a network interface 708 (e.g., Ethernet, FireWire, USB, etc.), input devices 710 (e.g., keyboard, mouse, etc.), and one or more computer-readable mediums 712. These components exchange communications and data using one or more buses 714 (e.g., EISA, PCI, PCI Express, etc.).

The term “computer-readable medium” refers to any medium that participates in providing instructions to a processor 702 for execution. The computer-readable medium 712 further includes an operating system 716 (e.g., Mac OS®, Windows®, Linux, etc.), a network communication module 718, a storage management module 720, and other applications 724.

The operating system 716 can be multi-user, multiprocessing, multitasking, multithreading, real-time and the like. The operating system 716 performs basic tasks, including but not limited to: recognizing input from input devices 710; sending output to display devices 704; keeping track of files and directories on computer-readable mediums 712 (e.g., memory or a storage device); controlling peripheral devices (e.g., disk drives, printers, etc.); and managing traffic on the one or more buses 714. The network communications module 718 includes various components for establishing and maintaining network connections (e.g., software for implementing communication protocols, such as TCP/IP, HTTP, Ethernet, etc.).

The storage management module 720 provides various software components for performing the various functions for identifying storage locations and generating corresponding header snips, as described with respect to FIGS. 1-6.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method comprising:
receiving a request to store one or more data items from a client device;
identifying one or more remote storage locations for storing the one or more data items;
creating header snips corresponding to the one or more remote storage locations; and
sending the header snips to the client device.

2. The method of claim 1, where identifying one or more remote storage locations includes examining heuristics associated with the data item to be stored.

3. The method of claim 2, where the heuristics include the size of the data item.

4. The method of claim 2, where the heuristics include a determined cost for the data item.

5. The method of claim 1, where receiving the request to store one or more data items includes receiving a fingerprint identifier for each of the one or more data items.

6. The method of claim 1, where creating a particular header snip includes generating a HTTP header for communicating with the particular interface of the corresponding identified remote storage location.

7. The method of claim 5, where the HTTP header includes a host, port, and URL associated with the remote storage location.

8. The method of claim 1, where creating a particular header snip includes security and access credentials for a corresponding remote storage location.

9. The method of claim 1, further comprising sending instructions to the client device on how to divide the one or more data items, where a header snip corresponds to each respective split portion.

10. The method of claim 9, where the instructions on how to divide the one or more data items includes a size of each split portion.

11. A method comprising:
receiving, from a client device, a request to download one or more data items;
identifying one or more remote storage locations in which the one or more data items are located;
creating one or more headers corresponding to the one or more remote storage locations; and
sending the header snips to the client device.

12. The method of claim 11, where receiving a request to download one or more data items includes receiving a fingerprint identifier for each of the one or more data items.

13. The method of claim 11, where identifying one or more remote storage locations includes using the received fingerprint identifiers to locate the corresponding remote storage locations for the requested one or more data items.

14. The method of claim 11, where creating a particular header includes generating a HTTP header for communicating a data request from the corresponding remote storage location.

15. The method of claim 14 where the HTTP header includes a host, port, and URL associated with the remote storage location.

16. A method comprising:
sending a request to a storage manager to store one or more data items;
receiving one or more header snips from the storage manager, each header snip corresponding to a particular remote storage location;
prepending each of the one or more header snips to corresponding one or more data items; and
sending the one or more data items to the corresponding remote storage locations.

17. A method comprising:
sending a request to a storage manager to retrieve one or more data items;
receiving one or more header snips from the storage manager, each header snip corresponding to a particular remote storage location;
prepending each of the one or more header snips to one or more corresponding requests for the one or more data items; and
sending the one or more requests to the corresponding remote storage locations.

18. A system comprising:
one or more computing devices operable to perform operations comprising:
receiving a request to store one or more data items from a client device;
identifying one or more remote storage locations for storing the one or more data items;
creating header snips corresponding to the one or more remote storage locations; and
sending the header snips to the client device.

19. The system of claim 18, where identifying one or more remote storage locations includes examining heuristics associated with the data item to be stored.

20. The system of claim 19, where the heuristics include the size of the data item.

21. The system of claim 19, where the heuristics include a determined cost for the data item.

22. The system of claim 18, where receiving the request to store one or more data items includes receiving a fingerprint identifier for each of the one or more data items.

23. The system of claim 18, where creating a particular header snip includes generating a HTTP header for communicating with the particular interface of the corresponding identified remote storage location.

24. The system of claim 23, where the HTTP header includes a host, port, and URL associated with the remote storage location.

25. The system of claim 18, where creating a particular header snip includes security and access credentials for a corresponding remote storage location.

26. The system of claim 18, further operable to perform operations comprising sending instructions to the client device on how to divide the one or more data items, where a header snip corresponds to each respective split portion.

27. The system of claim 26, where the instructions on how to divide the one or more data items includes a size of each split portion.

28. A system comprising:
one or more computing devices operable to perform operations comprising:
sending a request to a storage manager to store one or more data items;
receiving one or more header snips from the storage manager, each header snip corresponding to a particular remote storage location;
prepending each of the one or more header snips to corresponding one or more data items; and
sending the one or more data items to the corresponding remote storage locations.

29. A system comprising:
one or more computing devices operable to perform operations comprising:
sending a request to a storage manager to retrieve one or more data items;
receiving one or more header snips from the storage manager, each header snip corresponding to a particular remote storage location;
prepending each of the one or more header snips to one or more corresponding requests for the one or more data items; and
sending the one or more requests to the corresponding remote storage locations.
